(19) United States
(12) Patent Application Publication
(10) Pub. No.: US 2009/0138513 A1
(43) Pub. Date: May 28, 2009

(54) MULTIMEDIA FILE CO-PROCESSING SYSTEM AND METHOD

(75) Inventors: YU-ZHANG WEN, Shenzhen City (CN); ZAI-AN PAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/193,758

(22) Filed: Aug. 19, 2008

(30) Foreign Application Priority Data
Nov. 27, 2007 (CN) 200710202693.2

(51) Int. Cl. G06F 17/30

(52) U.S. Cl. 707/104.1; 707/E17.009

(57) ABSTRACT

A mobile electronic system for sharing a multimedia playlist over a communication network to a receiving mobile electronic device is disclosed. The system comprises a co-process request generating module configured for selecting one or more multimedia files from the plurality of multimedia files according to a predetermined selection, generating a co-process request according to the selected multimedia files, generating a proposed playlist according to the selected multimedia files. A feedback information receiving module is configured for receiving a matching playlist transmitted from the receiving mobile electronic device and saving the playlist as a co-processing playlist. A play controlling module is configured for playing multimedia files listed in the co-processing playlist.

### BACKGROUND

1. Field of the Invention

Embodiments of the present disclosure relate to sharing multimedia files, and more particularly to a system and method for sharing a multimedia playlist over a communication network.

2. Description of Related Art

Many electronic devices, such as cell phone, personal digital assistant (PDA), or computer may communicate with each other and play multimedia files, such as audio and video files. These multimedia files may be shared among other electronic files to be played synchronously. In one such method, a first communication device can request multimedia files to be played synchronously by a second communication device. The selected multimedia files are transmitted to a digital-to-analog converter (DAC) in order to convert the multimedia files into an analog signal, and then output the analog signal to an audio output device. Additionally, the selected multimedia files are mixed with a speech signal transmitted from an audio input device, such as microphone. The mixed signal is transmitted to the second communication device.

In the above mentioned method, in order to share the same multimedia file, the first communication device must first mix the speech signal transmitted from the audio input device with the multimedia file, and then transmit the mixed signal to the second communication device to output. Unfortunately, the process increases a load of the network between the first communication device and the second device, and the process furthermore requires a rapid transmitting speed and a stable network.

Therefore, what is needed is a multimedia file co-processing system and method which can decrease a load of a network while ensuring a transmitting speed and quality when sharing the same multimedia file between two electronic devices.

### SUMMARY

A mobile electronic system is for sharing a multimedia playlist over a communication network to a receiving mobile electronic device. The system comprises: a data storage that stores a plurality of multimedia files; a co-process request generating module configured for selecting one or more multimedia files from the plurality of multimedia files according to a predetermined selection, generating a co-process request according to the selected multimedia files, generating a proposed playlist according to the selected multimedia files, and sending the co-process request and the proposed playlist to the receiving mobile electronic device; a feedback information receiving module configured for receiving a matching playlist transmitted from the receiving mobile electronic device and saving the playlist as a co-processing playlist; and a play controlling module configured for playing multimedia files listed in the co-processing playlist from the first data storage.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of the multimedia files co-processing system. Moreover, in the drawings, like reference numerals designate corresponding parts throughout several views.

FIG. 1 is an architectural diagram of one embodiment of a multimedia file co-processing system of the present disclosure.

FIG. 2 is a block diagram of one embodiment of main function modules of a sending party.

FIG. 3 is a block diagram of one embodiment of main function modules of a receiving party.

FIG. 4 is a flowchart of one embodiment of a multimedia file co-processing method.

### DETAILED DESCRIPTION OF CERTAIN INVENTIVE EMBODIMENTS

As used herein, the term, “multimedia files” or “multimedia file” refer to electronic audio and video files. It may be understood that a multimedia file may comprise a playlist listing one or more multimedia files to be executed/played by an electronic device. Furthermore, the multimedia file comprises metadata, such as an artist name, an album name, and a file address, for example.

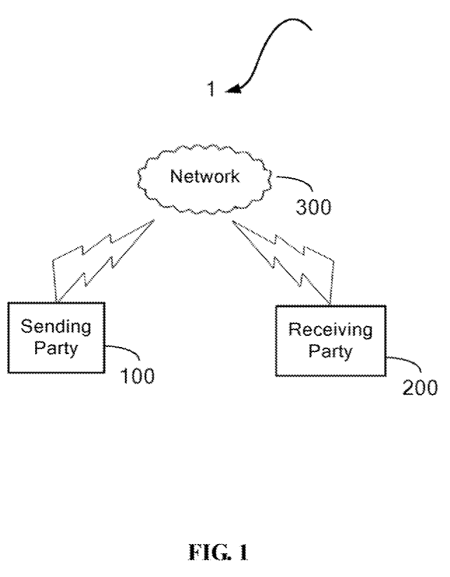

FIG. 1 is an architectural diagram of one embodiment of a multimedia file co-processing system 1 of the present disclosure. The system 1 includes a sending party 100 and a receiving party 200 communicating over a network 300. The sending party 100 and the receiving party 200 may share a same playlist between the two parties 100, 200 in order to play one or more multimedia files, such as a song, existing on both of the two parties 100, 200. In one embodiment, the sending party 100 and the receiving party 200 may be any electronic device with a multimedia playing function and a vocal communication function, such as a personal digital assistant (PDA), cellphone, or computer, for example. The network 300 can be the Internet or a wireless network such as a general packet radio service (GPRS).

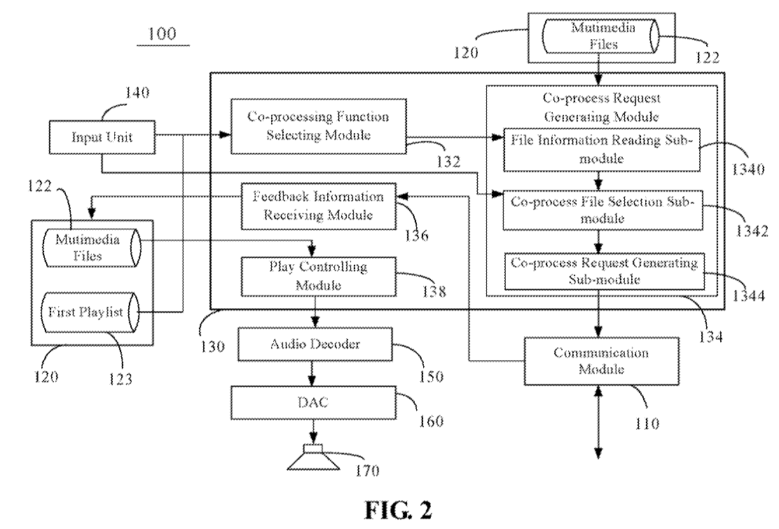

FIG. 2 is a block diagram of one embodiment of the sending party 100 including various function modules. The sending party 100 includes a data storage 120 configured for storing a plurality of multimedia files 122 and a first playlist 123. The first playlist 123 records any metadata of the multimedia files 122 and stores the metadata in a tabular form, in one embodiment, such as in Table 1. For example, in reference to Table 1, a first row shows “AA” as a multimedia file title, “John” as an artist name of the multimedia file, “A” as an album name of the multimedia file, and “XXXXXXX1” as a file address of the multimedia files 122. The data storage 120 may be a hard disk drive, a flash drive, for example.

TABLE 1

| Multimedia file | | | |
|---|---|---|---|
| title | Artist name | Album name | File address |
| AA | John | A | XXXXXXX1 |
| BB | Rose | B | XXXXXXX2 |
| CC | Cat | C | XXXXXXX3 |
| DD | Stone | D | XXXXXXX4 |

The sending party 100 further includes a processing unit 130. The processing unit 130 includes a co-processing function activating module 132, a co-process request generating module 134, a feedback information receiving module 136, and a play controlling module 138.

The co-processing function activating module 132 is configured for playing the multimedia files 122 of the sending party 100 according to operations of the user via an input unit 140.

The co-processing multimedia files generating module 134 is configured for determining which of the multimedia files 122 need to be synchronously played between the sending party 100 and the receiving party 200, and for generating a co-processing request according to a determined result. The co-processing multimedia files generating module 134 includes a file information reading sub-module 1340, a co-process file selection sub-module 1342, and a co-process request generating sub-module 1344.

The file information reading sub-module 1340 is configured for reading the first playlist 123 from the data storage 120, and displaying the first playlist 123 on a display (not shown) of the sending party 100.

The co-process file selection sub-module 1342 is configured for selecting multimedia files which have to be played synchronously between the two parties 100, 200 from the first playlist 123 according to selection inputs corresponding to the first playlist 123. For example, in reference to Table 1, multimedia files AA, BB, and CC in the first playlist 123 may be selected as multimedia files which have to be played synchronously between the two parties 100, 200. The selected multimedia files form a proposing playlist. The co-process request generating sub-module 1344 is configured for generating the co-process request for the proposing playlist, and sending the co-process request and the proposing playlist to the receiving party 200. After receiving the co-process request and the proposing playlist, the receiving party 200 generates feedback information according to the proposing playlist and the multimedia files and sends the feedback information to the sending party 100. The feedback information may be a matching playlist or a feedback signal. If one or more multimedia files listed in the proposing playlist exist in the receiving party 200, the receiving party 200 generates a matching playlist listing the one or more multimedia files that exist in the sending party 100 and the receiving party 200. If none of the multimedia files listed in the proposing playlist exist in the receiving party 200, then the receiving party generates a feedback signal. A detailed description on generating the feedback information will be described below.

The feedback information receiving module 136 is configured for receiving the feedback information from the receiving party 200 through a communication module 110.

The feedback information receiving module 136 notifies the co-processing multimedia files generating module 134 to generate a new proposing playlist if the feedback signal which represents that none of multimedia files listed in the proposing list exists in the receiving party 200 is received.

The feedback information receiving module 136 stores the matching playlist to the data storage 120 as a co-processing playlist and updates the file address of each multimedia files listed in the co-processing playlist if the matching playlist is received. The play controlling module 138 is for reading the multimedia files 122 listed in the co-processing playlist from the data storage 120 orderly according to the file address recorded in the co-processing playlist and sending the multimedia files to an audio decoder 150 to decode to digital audio information. The digital audio information is transmitted to a digital-to-analog converter (DAC) 160 to convert to analog information. The converted analog information is transmitted to the audio output device 170 to output.

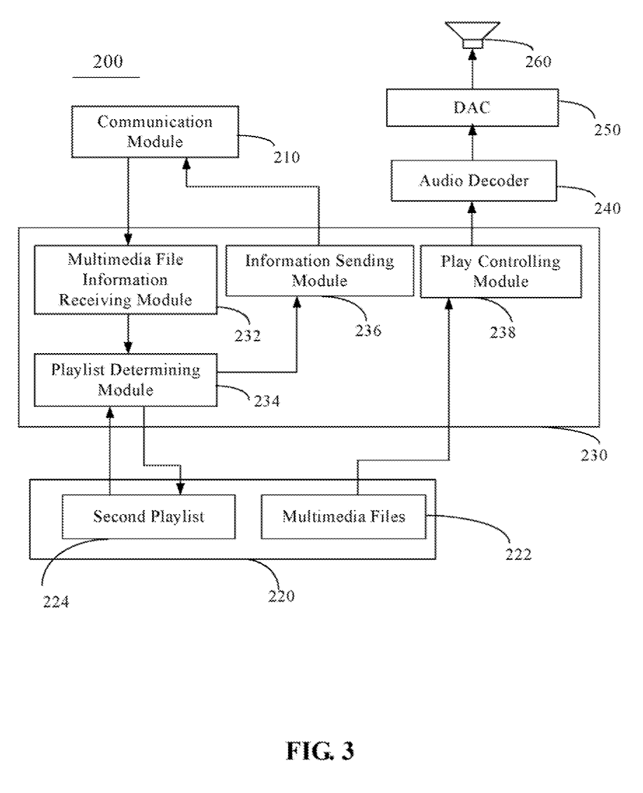

FIG. 3 is a block diagram of one embodiment of main function modules of the receiving party 200. The receiving party 200 includes a data storage 220 for storing a second playlist 224 and a plurality of multimedia files 222. The second playlist 224 records the same metadata of the multimedia files 222 as the first playlist 124. The receiving party 200 further includes a processing unit 230. The processing unit 230 includes a multimedia file information receiving module 232, a playlist determining module 234, an information sending module 236, and a play controlling module 238.

The multimedia file information receiving module 232 is configured for receiving the co-process request and the proposing playlist from the sending party 100 through a communication module 210 of the receiving party 200. The playlist determining module 234 determines if the multimedia files listed in the proposing playlist exists in the data storage 220 according to the metadata recorded in the proposing playlist and the second playlist 224 and generates the feedback information. If none of the multimedia files listed in the proposing playlist exists in the data storage 220, the playlist determining module 234 generates the feedback signal to the sending party 100. If there are multimedia files exist in the data storage 220, the playlist determining module 234 generates the matching playlist according to the determined multimedia files. For example, if the multimedia files AA and CC exists in the data storage 220 of the receiving party 200, the playlist determining module 234 lists multimedia files AA and CC to generate the matching playlist. The feedback information sending module 236 is for sending the feedback information to the sending party 100. The play controlling module 238 is configured for reading the multimedia files listed in the matching playlist from the data storage 220 according to the file address recorded in the matching playlist, and sending the read multimedia files to an audio decoder 250 of the sending party 100 to decode the multimedia files 222 to digital audio information. The decoded digital audio information is transmitted to a digital-to-analog converter (DAC) 260 of the receiving party 200 to convert the decoded digital information into analog information. The converted analog information is transmitted to the audio output device 270 to output. The data storage 220 may be a hard disk drive or a flash drive, for example.

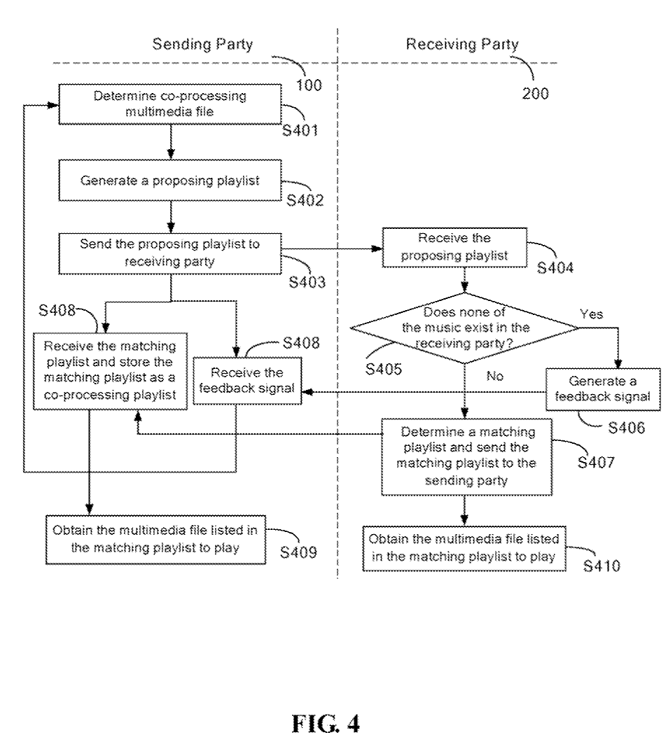

FIG. 4 is a flowchart of a multimedia file co-processing method of the present disclosure. In block S401, after the multimedia files co-processing function of the sending party 100 is activated, the sending party 100 determines which multimedia file listed in the first playlist 123 needs to be played synchronously between the two parties 100, 200 according to selection operations from the user. The detailed description of determining which multimedia files is to be played synchronously is described with respect to FIG. 2.

In block S402, the sending party 100 generates the proposing playlist according to the determined multimedia files.

In block S403, the sending party 100 sending the proposing playlist to the receiving party 200 via the communication module 110 of the sending party 100.

In block S404, the receiving party 200 receives the proposing playlist transmitted from the sending party 100.

In block S405, the receiving party 200 determines if there are none of the multimedia files listed in the proposing playlist exists in the receiving party.

If there are none of the multimedia files listed in the proposing playlist exists in the receiving party 200, in block S406, the receiving party 200 generates a feedback signal to the sending party.

If there are multimedia files listed in the proposing playlist exist in the receiving party, in block S407, the receiving party 200 generates the matching playlist, and sends the matching playlist to the sending party 100. The detailed description of generating the matching playlist is described with respect to FIG. 3.

In block S408, the sending party 100 receives the feedback information from the receiving party. If the feedback signal is received, the procedure goes to block S401. If the matching playlist is received, the sending party stores the matching playlist as the co-processing playlist to the data storage 120 of the sending party 100.

In block S407, the sending party 100 reads the multimedia files listed in the matching playlist from the data storage 120 of the sending party 100 to play.

In block S408, the receiving party 200 reads the multimedia files listed in the co-processing playlist from the data storage 220 of the receiving party 200 to play.

Although the present invention has been specifically described on the basis of a preferred embodiment, the present disclosure is not to be construed as being limited thereto. Various changes or modifications may be made to the embodiment without departing from the scope and spirit of the present disclosure.

What is claimed is:

1. A mobile electronic system for sharing a multimedia playlist over a communication network to a receiving mobile electronic device, the system comprising:
a data storage that stores a plurality of multimedia files;
a co-process request generating module configured for selecting one or more multimedia files from the plurality of multimedia files according to a predetermined selection, generating a co-process request according to the selected multimedia files, generating a proposed playlist according to the selected multimedia files, and sending the co-process request and the proposed playlist to the receiving mobile electronic device;
a feedback information receiving module configured for receiving a matching playlist transmitted from the receiving mobile electronic device and saving the matching playlist as a co-processing playlist; and
a play controlling module configured for playing multimedia files listed in the co-processing playlist from the first data storage.

2. The system as described in claim 1, wherein the feedback information receiving module is further configured for receiving a feedback signal and notifying the co-process request generating module to generate a new proposing playlist when the feedback signal is received.

3. A mobile electronic system for receiving a multimedia playlist over a communication network from a sharing mobile electronic device, the system comprising:
a data storage that stores a plurality of multimedia files; a multimedia files information receiving module for receiving a co-process request and a proposing playlist from the sharing mobile electronic device;
a playlist determining module configured for determining if one or more multimedia files listed in the proposing playlist exist in the data storage, and generating a matching playlist according to the determined multimedia files;
an information sending module configured for sending the matching playlist to the sharing mobile electronic device; and
a play controlling module configured for playing the multimedia files listed in the matching playlist from the second data storage.

4. The system as described in claim 3, wherein the playlist determining module is further configured for generating a feedback signal if none of multimedia files listed in the proposing playlist exist in the data storage.

5. A multimedia file co-processing method for a sending mobile electronic device adapted to communicate with a receiving mobile electronic device over a communication network, the method comprising:
(a) selecting multimedia files to be played synchronously between the sending mobile electronic device and the receiving mobile electronic device, and generating a proposing playlist according to the selected multimedia files;
(b) generating a co-process request;
(c) sending the co-process request and the proposing playlist to the receiving mobile electronic device;
(d) receiving the co-process request and the proposing playlist from the sending mobile electronic device;
(e) determining if the multimedia files listed in the proposing playlist exist in the receiving mobile electronic device;
(f) generating a matching playlist according to determined multimedia files upon the condition that multimedia files listed in the proposing playlist exist in the receiving mobile electronic device;
(g) sending the matching playlist to the sending mobile electronic device
(h) receiving the matching playlist transmitted from the receiving mobile electronic device and saving the matching playlist as a co-processing playlist;
(i) reading multimedia files listed in the co-processing playlist from the sending mobile electronic device to play; and
(j) reading multimedia files listed in the matching playlist from the receiving mobile electronic device to play.

6. The method as described in claim 5, further comprising:
sending a feedback signal to the sending mobile electronic device upon the condition that none of multimedia files listed in the proposing playlist exist in the receiving mobile electronic device;
receiving the feedback signal and going to block (f).
